(19) United States
(12) Patent Application Publication
(10) Pub. No.: US 2010/0326186 A1
(43) Pub. Date: Dec. 30, 2010

(54) FILL LEVEL DETECTION APPARATUS

(75) Inventors: Norbert Kamp, Steinheim (DE); Jan Kaluza, Boeblingen (DE); Andreas Lutz, Friolzheim (DE); Dirk Buelow, Leifelden-Echterdingen (DE); Horst Kretschmers, Leutenbach (DE); Joerg Grothe, Bietgheim-Bissingen (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 12/775,233

(22) Filed: May 6, 2010

(30) Foreign Application Priority Data
May 6, 2009 (DE) 10 2009 020 770.8

(51) Int. Cl. G01F 23/26

(52) U.S. Cl. 73/304 C

(57) ABSTRACT

A fill level detection apparatus (23) is introduced for ascertaining a fill level in a storage tank (19) for a liquid reducing agent for use in an exhaust gas aftertreatment device (3), having a fill level detector (21) and a driving and evaluating unit (22), which are connected to each other with electrical lines (47a, 47b, 47c) and with respect to DC-currents are decoupled from each other by capacitors (45), which are connected in series with said electrical lines, and with respect to AC-currents are coupled with each other. Said fill level detection apparatus is thereby characterized in that the capacitors (45) are disposed as part of the fill level detector (21) separated from the driving and evaluating unit (22) by the electrical lines (47a, 47b, 47c).

This application claims benefit of Serial No. 10 2009 020 770.8, filed 6 May 2009 in Germany and which application is incorporated herein by reference. To the extent appropriate, a claim of priority is made to the above disclosed application.

### BACKGROUND

The invention relates to a fill level detection apparatus for ascertaining a fill level in a storage tank for a liquid reducing agent for use in an exhaust gas aftertreatment device.

Fill level detection apparatuses for ascertaining a fill level in a storage tank for a liquid reducing agent to be introduced into an exhaust gas aftertreatment device are known from the market. Exhaust gas aftertreatment devices are required by law. They reduce the environmentally harmful nitrogen oxides contained in the untreated emissions of an internal combustion engine. In, for example, a method for selective catalytic reduction (SCR), liquid reducing agents, as, for example, a urea-water solution, are used. In the SCR method, ammonia is released from the urea-water solution by means of a hydrolysis reaction. Said ammonia reduces environmentally harmful nitrogen oxides to harmless nitrogen and water in a catalytic converter in the exhaust gas tract of the internal combustion engine. This so-called SCR method for purifying exhaust gas is known from the technical field.

The fill level detection apparatus is used to acquire the fill level in the storage tank for the liquid reducing agent (for example so-called “Adblue”) and to elicit a timely refilling of the reducing agent. Fill level detectors are thus, for example, in use, which have measuring electrodes of various lengths that are submerged in the reducing agent. With the aid of electrical measurements, which utilize the electrical conductivity or the capacitive properties of the reducing agent, the fill level can be ascertained by virtue of the fact that detection is made of which electrodes are still submerged in the reducing agent. This is than an indication of the fill level. The measurements are preferably carried out with a pulse-width modulated (PWM) method with signal pulses that are as short as possible and with a small duty cycle in order to prevent a possible electrolysis of the reducing agent. The electrolysis would change the reducing agent (for example urea) and the electrodes, which would render the reducing agent unusable for its actual use in the catalytic converter and place wear on the electrodes. In addition, hydrogen would develop from the electrolysis, which in connection with oxygen forms explosive oxyhydrogen.

The known fill level detection apparatuses preferably work with a capacitive sensor, which requires a capacitive decoupling in the control unit. These fill level detection apparatuses have the disadvantage that in the event of a fault, for example a short circuit to a battery voltage, they can only protect the fill level detector in a very complex manner. This fault can result from, for example, the insulation being rubbed off on the electrical feeder cables to the fill level detector or by other influences caused by a fault. The short circuited current can thereby initially flow unhindered into the fill level detector and can flow to ground via the electrically conductive fluid, which can lead to an undesirable electrolysis of the reducing agent. This is stopped after a diagnosis is made in the evaluating unit by an additional circuit and software function in said evaluating unit. With regard to the software function required for this operation, standard applications can not be relied upon, and a customized function has to be developed for this special case. This increases costs. The electronic evaluating unit is protected from a short circuit at the input in a known fashion by a capacitor, which is disposed at the input to the evaluating unit.

### SUMMARY

It is the aim of the invention to specify a reliably working, cost effective fill level detection apparatus, wherein an electrolysis of the reducing agent in the storage tank is prevented in each case by simple means.

The aim is met according to the invention by virtue of the fact that the capacitor is disposed as part of the fill level detector separated from the driving and evaluating unit by the electrical wiring. The capacitor is thereby disposed at the input to the fill level detector and serves as a safeguard from direct current, for example in the case of a short circuit to the battery, which could occur in the event of a fault. The idea underlying the invention is on the one hand to protect the fill level detector from short circuit current (direct current) by a simple, discrete component, namely the capacitor, and on the other hand to protect the driving and evaluating unit by simple software measures because the short circuit current substantially corresponds to a predefinable case and is therefore easy to diagnose with a standard software. When a fault is detected, safeguards, which now only have to affect the driving and evaluating unit, can then be taken by software decisions in the driving and evaluating unit. As a first safeguard, a switch in the feeder line to ground can thus, for example, be opened. The use of the capacitor on the input side of the fill level detector is possible because the ascertainment of the fill level in the storage tank is conducted in a known manner with a pulse-width modulated signal (for example at approximately 5 kHz). The capacitor can thereby be dimensioned such that it is of low resistance at this frequency, i.e. is conducting. By the use of standard software for fault recognition and the capacitor for decoupling, the invention is simple to implement and is also for this reason cost effective.

Important characteristics for the invention can furthermore be found in the following description and in the drawing. In so doing, the characteristics can be important for the invention individually as well as in various combinations without explicit reference being made in each case to this fact. Advantageous modifications are found in the sub-claims.

### BRIEF DESCRIPTION OF THE DRAWINGS

An embodiment of the invention is exemplarily explained below with the aid of the figures. The following are shown:

FIG. 1 is a schematic depiction of an internal combustion engine with an exhaust gas aftertreatment device;

FIG. 2 is a detailed depiction of a fill level detector and a driving and evaluating unit from FIG. 1;

FIG. 3 is a schematic diagram of the fill level detector and the driving and evaluating unit from the technical field;

FIG. 4 is a schematic diagram of the fill level detector according to the invention and driving and evaluating unit; and

FIG. 5 is a diagram with different possible current levels in the fill level detector.

### DETAILED DESCRIPTION

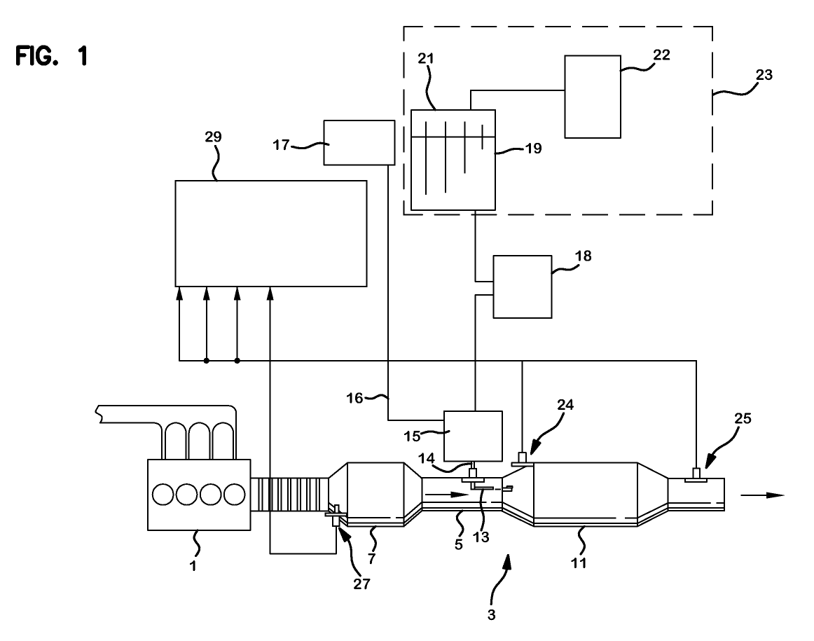

An internal combustion engine 1 having an exhaust gas aftertreatment device 3 is schematically depicted in FIG. 1 in a greatly simplified manner. The exhaust gas aftertreatment device 3 has an exhaust pipe 5, an oxidation catalytic converter 7 and a SCR catalytic converter 11. A particle filter is not depicted, which normally is disposed downstream of the oxidation catalytic converter 7. The direction of flow of the exhaust gas through the exhaust pipe 5 is indicated by arrows (without reference numerals).

In order to supply the SCR catalytic converter 11 with a reducing agent, for example a urea-water solution, a spray pipe 13 for the urea-water solution is disposed in the exhaust pipe 5 upstream of the SCR catalytic converter 11. If needed, the urea-water solution is injected via said spray pipe 13 by means of compressed air into the exhaust pipe 5 upstream of the SCR catalytic converter 11. The spray pipe 13 is connected to the metering module 15 via a metering line 14. In addition, a pressure line 16 for supplying compressed air from a compressed air generation unit 17 or a compressed air tank is provided at the metering module 15.

Beside the spray pipe 13, the metering line 14 and the metering module 15, the entire metering system comprises a metering pump 18 as well as a storage tank 19 for the urea-water solution. The storage tank 19 and the metering pump 18 as well as the metering pump 18 and the metering module 15 are in each case hydraulically connected to each other by lines (without reference numerals) so that the metering pump 18 supplies the metering module 15 with reducing agent from the storage tank 19.

A fill level detector 21 is disposed at the storage tank 19. The fill level detector 21 is electrically connected to a driving and evaluating unit 22. The driving and evaluating unit 22 can be a separate unit, it can however also be integrated in a control unit 29 of the internal combustion engine 1. The fill level detector 21 and the driving and evaluating unit 22 together form the fill level detection apparatus 23.

For the sake of completeness, the sensors disposed in the exhaust gas system should be mentioned, namely a nitrogen oxide sensor 25 as well as temperature sensors 24 and 27, with which the state of the exhaust gas is acquired. These sensors 24, 25 and 27 are connected to the control unit 29, which in addition controls the internal combustion engine 1, via signal lines (without reference numerals).

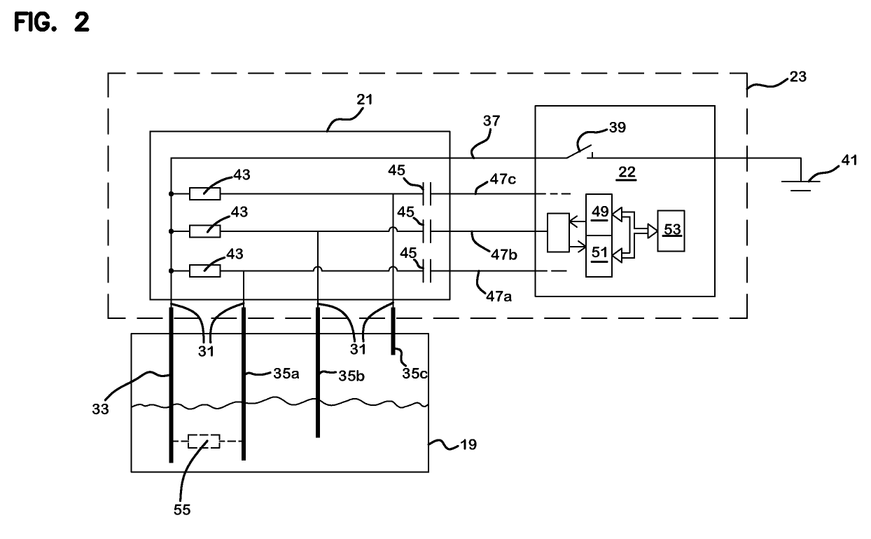

FIG. 2 shows in detail the fill level detection apparatus 23 in a preferred embodiment. The fill level detector 21 essentially comprises four connecting lines 31 to four electrodes 33, 35a, 35b, 35c, which are submerged in the storage tank 19. The electrode depicted on the left side in FIG. 2 thereby represents a base electrode 33. The additional electrodes 35a, 35b, 35c are disposed parallel to the base electrode 33 and represent the measuring electrodes 35a, 35b, 35c. The three measuring electrodes 35a, 35b, 35c have in each case a different length, a first measuring electrode 35a having the same length as the base electrode 33 and extending approximately to a base surface of the storage tank 19. A second measuring electrode 35b is slightly shortened in comparison to the first measuring electrode 35a. A third measuring electrode 35c extends only a slight way into the storage tank 19.

The four connecting lines 31 are fed to the fill level detector 21. The connection of the base electrode 33 is then directly looped through the driving and evaluating unit 22 via a first cable connection 37 and then led further via a switch 39 to an electrical reference point 41 (for example ground). The connections of the measuring electrodes 35a, 35b, 35c have in each case a constant resistance 43 in the direction of the base electrode 33 and are directed in the fill level detector 21 to the driving and evaluating unit 22 in each case via a capacitor 45 and in each case a second cable connection 47a, 47b, 47c. The driving and evaluating unit 22 substantially comprises a pulse-width modulator 49 for each measuring electrode 35a, 35b, 35c, a signal shaping network 50 and an analog-digital converter 51. FIG. 2 shows for the sake of clarity only a pulse-width modulator 49, a signal shaping network 50 and an analog-digital converter 51, which are connected up to the line 47b. A processor 53 activates the pulse-width modulator 49 and receives signals from the analog-digital converter 51. The signal shaping network is connected up to the associated measuring electrode, in this instance the measuring electrode 35b so that the signal going out from the pulse-width modulator 49 is changed as a function of electrical influences, which are fed in via the measuring electrode 35b. The electrical influence primarily reflects whether the measuring electrode 35b is submerged in the fluid and is thereby conductively connected to the base electrode 33 via said fluid. Using this information, a rough item of information about the fill level is indirectly reflected in the signal, which is present at the analog-digital converter 51 and is provided to the processor 53 for evaluation in digital form.

The processor 53 is equipped for the purpose, particularly programmed for the purpose, of activating the measuring electrodes 35 and of evaluating the digital signal received from the analog-digital converters 51. It is particularly programmed for the purpose of evaluating the signals for controlling the method of the fill level detection with a fault recognition routine.

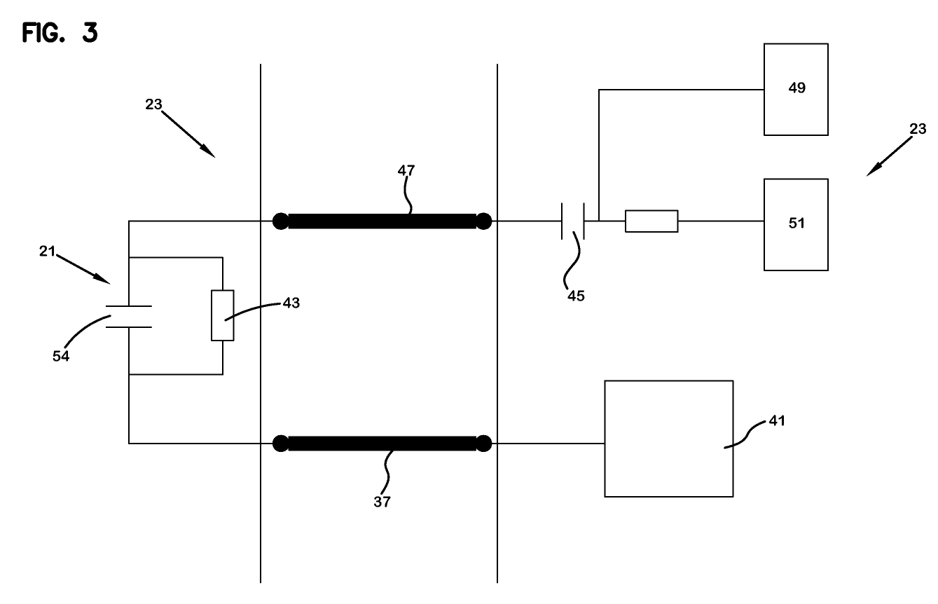

FIG. 3 schematically shows the fill level detection apparatus 23 from the technical field. It is thereby the case that such elements and regions, which are functionally equivalent to the elements of FIG. 2, bear the same reference numerals and are not once again explained in detail. The fill level detector 21 is together with the electrodes 33 and 35 symbolically depicted by a single fixed resistor 43 and a capacitor connected in parallel to it. In contrast to FIG. 2, the fill level detector 21 of FIG. 3 does not have the capacitor 45. This capacitor 45 is disposed in the technical field in the driving and evaluating unit 22 at the input of said driving and evaluating unit 22.

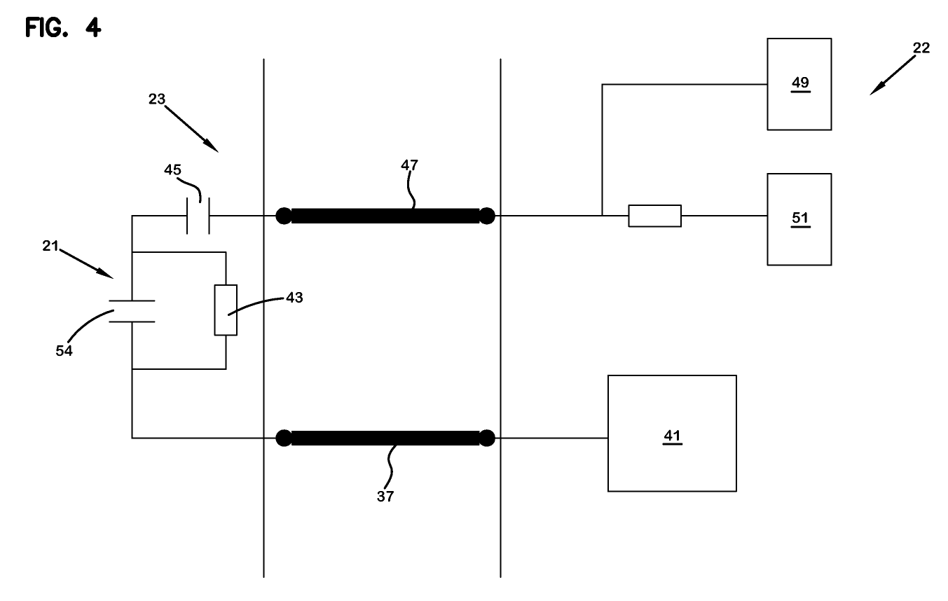

According to the invention, the capacitor 45 is in each case transferred from the driving and evaluating unit 22 into the fill level detector 21. FIG. 4 shows the situation according to the invention.

The fill level detection apparatus 23 from the technical field works according to the following method: it is thereby assumed that the fill level detector 21 has the same electrode arrangement, as it is depicted in FIG. 2. Reference is therefore initially made to FIG. 2 for the explanation of the method. The liquid, electrically conductive reducing agent constitutes an electrical resistor 55, whose resistance is substantially smaller than the constant resistance 43, between the base electrode 33 and one of the measuring electrodes 35 when the corresponding measuring electrode is submerged in said reducing agent. As seen electrically both resistors 43 and 55 are connected in parallel, which means that the total resistance of the two resistors 43 and 55 connected virtually in parallel is substantially smaller than the constant resistance 43. Because measuring electrodes 35 of different lengths having respectively separate cable connections 47 are submerged in the reducing agent, the driving and evaluating unit 22 can ascertain a fill level, particularly a critical fill level, because only the constant resistance 43 takes effect for the driving and evaluating unit 22 when the measuring electrodes 35 are not submerged in the reducing agent and the total resistance from the resistors 43 and 55 connected in parallel takes effect when the measuring electrodes 35 are submerged in said reducing agent.

It is necessary for the measurement of the resistance that a voltage is applied between the base electrode 33 and the measuring electrodes 35, whereby a current flows through the reducing agent. In order to prevent an electrolysis of the reducing agent by the measuring current, the resistance measurement is carried out with a pulse-width modulated signal having a small duty cycle so that the signal pulse is very short.

As a result of a fault in the region of the fill level detection apparatus 23, for example resulting from the insulation of the electrical feeder cable 47 to the measuring electrodes 35 being rubbed off, it is possible for a short circuit to occur and for a battery current (direct current) to be supplied to the electrical feeder cable 47 and in so doing also to the fill level detector 21. This would result in a lasting electrolysis of the liquid reducing agent. The driving and evaluating unit 22 is protected by the arrangement of the capacitor 45 according to the invention because said driving and evaluating unit 22 DC decouples the measuring electrodes 35a, 35b, 35c from the lines 47.

In other words, the arrangement of the capacitor 45 at the input of the fill level detector 21 prevents an electrolysis of the reducing agent in the storage tank 19 when a fault occurs. In the case of a fault, the short circuit current now present at the driving and evaluating unit 22 constitutes a substantially predefinable condition, for example at the input of the analog-digital converter, which can be recognized in the driving and evaluating unit 22 by a specific query in the software. The protective mechanisms are then initiated by software controlled actions, like, for example, an opening of the switch 39.

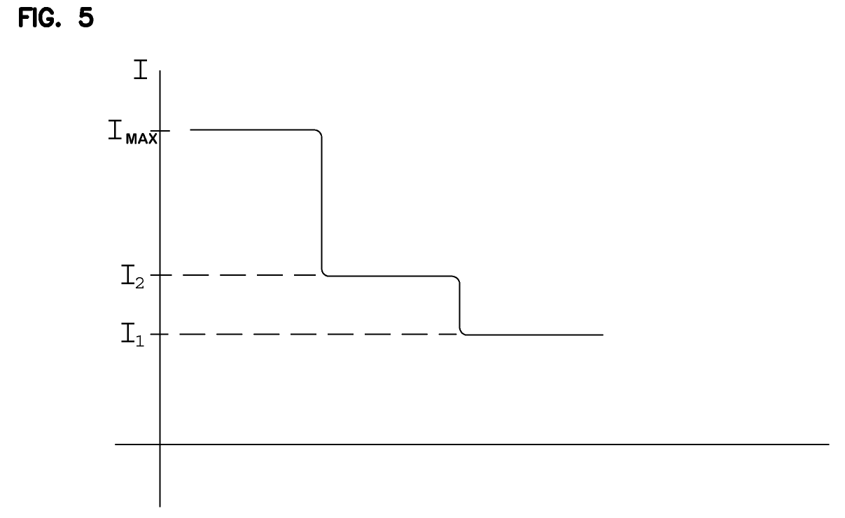

FIG. 5 shows a diagram with different current levels, which can occur in the driving and evaluating unit 22 during the operation and which are diagnosed by the method according to the invention. The current I₁ constitutes the current, which flows between a measuring electrode not submerged in the reducing agent via a fixed resistor 43. Current I₂ constitutes the current, which flows between a measuring electrode submerged in the reducing agent and the parallel connected electrical resistor 55 of the reductant fluid via the fixed resistor 43. It should be noted at this point that the depiction of FIG. 5 is purely qualitative and that I₁ and I₂ would depict a pulse-width modulation upon a pulse-width modulated signal being generated. FIG. 5 however illustrates well the qualitative effect of the resistance which varies with the fluid level.

As a result of the separate electric power supply of the individual measuring electrodes to the driving and evaluating unit 22, it is possible to identify the measuring electrodes 35, which are still submerged in the reducing agent and—if necessary in the case of a low fill level of the reducing agent having been diagnosed—to emit an optical or acoustic warning signal, for example on the dashboard of the motor vehicle if only two or even one single measuring electrode(s) 35 still are submerged in the reducing agent. Iₘₐₓ shows the short circuit current which occurs in the case of a fault, from which the fill level detector 21 is on the one hand protected by the capacitor 45, and on the other hand the driving and evaluating unit 22 recognizes the fault and initiates appropriate safeguards as previously described.

1. Fill level detection apparatus for ascertaining a fill level in a storage tank for a liquid reducing agent for use in an exhaust gas aftertreatment device, having a fill level detector and a driving and evaluating unit, which are connected to each other with electrical lines and with respect to DC-currents are decoupled from each other by capacitors, which are connected in series with said electrical lines, and with respect to AC-currents are coupled with each other, wherein the capacitors are disposed as part of the fill level detector separated from the driving and evaluating unit by the electrical lines.

2. Fill level detection apparatus according to claim 1, wherein the fill level detector has a base electrode and at least one measuring electrode, said base electrode and each measuring electrode being connected with a separate electrical line to the driving and evaluating unit, and each of the capacitors in each case being disposed in series between an electrical line and the associated measuring electrode.

3. Fill level detection apparatus according to claim 1, wherein within the fill level detector the base electrode and in each case one measuring electrode are in each case connected to one another by a fixed electrical resistor.

4. Fill level detection apparatus according to claim 1, wherein the measuring electrodes have different lengths so that they are submerged or not submerged in the reducing agent in the storage tank depending upon the fill level and wherein the reducing agent has a smaller electrical resistance than the fixed electrical resistor

5. Fill level detection apparatus according to claim 1, wherein the length of the base electrode corresponds to the length of the longest measuring electrode.
